(19) United States
(12) Patent Application Publication
(10) Pub. No.: US 2008/0005858 A1
(43) Pub. Date: Jan. 10, 2008

(54) PAINT APPLICATOR

(76) Inventor: Miguel Wang, Taichung City (TW)

Correspondence Address: CHRISTIE, PARKER & HALE, LLP, PO BOX 7068, PASADENA, CA, 91109-7068, US

(21) Appl. No.: 11/773,346

(22) Filed: Jul. 3, 2007

(30) Foreign Application Priority Data
Jul. 7, 2006 (TW) 095124824

(51) Int. Cl. B05C 17/02

(52) U.S. Cl. 15/104.001

(57) ABSTRACT

A paint applicator includes an applying unit and a joining unit. The applying unit includes a flat casing, an applying plate covering the flat casing and cooperating with the flat casing to define a receiving space, and at least one roller mounted on the flat casing externally of and at one side of the receiving space. The applying plate has a plurality of paint outlet holes spaced apart from each other. The roller projects outward from the flat casing and is rotatable about a first axis transverse to the applying plate. The joining unit includes a joining member connected pivotally to the flat casing, and opposite to the applying plate and rotatable around a second axis parallel to the first axis. The joining member includes an output passage communicated fluidly with the receiving space of the applying unit and adapted to supply paint material to the receiving space.

### CROSS-REFERENCE TO RELATED APPLICATION

This application claims priority of Taiwanese Application No. 095124824, filed on Jul. 7, 2006.

### BACKGROUND OF THE INVENTION

1. Field of the Invention

The invention relates to a paint applicator, more particularly to a paint applicator for painting an edge portion of a wall.

2. Description of the Related Art

Referring to FIGS. 1 and 2, a conventional paint applicator 1 for painting an edge portion of a wall, for example, an edge portion of a first wall 21 proximate to a second wall 22, includes a hollow rod handle 11 and an applying unit 12.

The hollow rod handle 11 defines a passage 111 for inputting paint. The applying unit 12 includes a flat casing 122, an applying plate 121 covering the flat casing 122 and cooperating with the flat casing 122 to define a receiving space 124, and two rollers 123 mounted on the flat casing 122 externally of and at one side of the receiving space 124. The applying plate 121 has a plurality of paint outlet holes 125. Each of the rollers 123 is rotatable about a respective axis transverse to the applying plate 121. The hollow rod handle 11 is mounted on the flat casing 122, and the passage 111 is communicated fluidly with the receiving space 124.

In use, the paint flows from the passage 111 into the receiving space 124, and flows out of the receiving space 124 through the paint outlet holes 125.

However, since the hollow rod handle 11 is not rotatable relatively to the applying unit 12, the flexibility of the paint applicator 1 is limited.

### SUMMARY OF THE INVENTION

Therefore, the object of the present invention is to provide a paint applicator which can overcome the aforesaid disadvantage of the prior art.

A paint applicator according to this invention includes an applying unit and a joining unit. The applying unit includes a flat casing, an applying plate covering the flat casing and cooperating with the flat casing to define a receiving space, and at least one roller mounted on the flat casing externally of and at one side of the receiving space. The applying plate has a plurality of paint outlet holes spaced apart from each other. The roller projects outward from the flat casing and is rotatable about a first axis transverse to the applying plate. The joining unit includes a joining member connected pivotally to the flat casing, and opposite to the applying plate and rotatable around a second axis parallel to the first axis. The joining member includes an output passage communicated fluidly with the receiving space of the applying unit and adapted to supply paint material to the receiving space.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary sectional view of a conventional paint applicator;

FIG. 2 is a fragmentary schematic view of the conventional paint applicator;

FIG. 3 is a fragmentary sectional view of a first preferred embodiment of a paint applicator according to this invention;

FIGS. 4 to 6 are schematic views illustrating the first preferred embodiment in a state of use;

FIG. 7 is a fragmentary sectional view of a second preferred embodiment of a paint applicator according to this invention;

FIG. 8 is a partly sectional schematic view of a hollow rod handle of the second preferred embodiment; and

FIGS. 9 to 11 are schematic views illustrating the second preferred embodiment in a state of use.

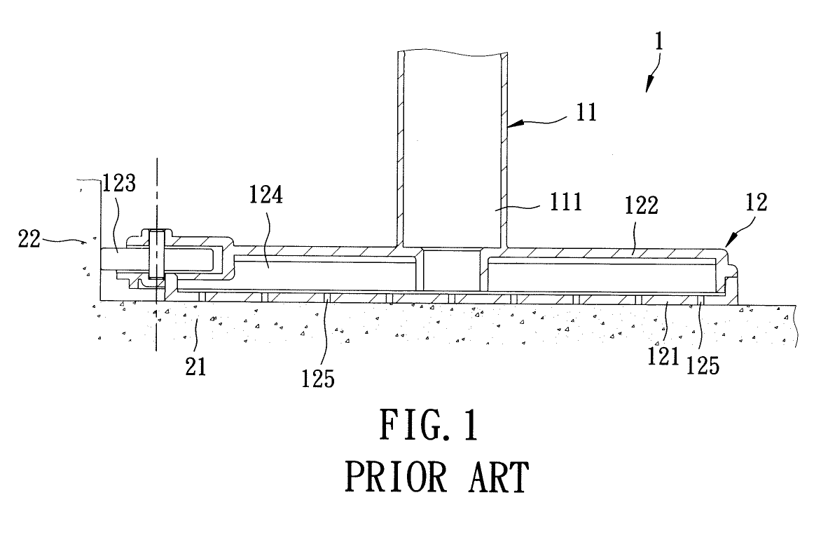

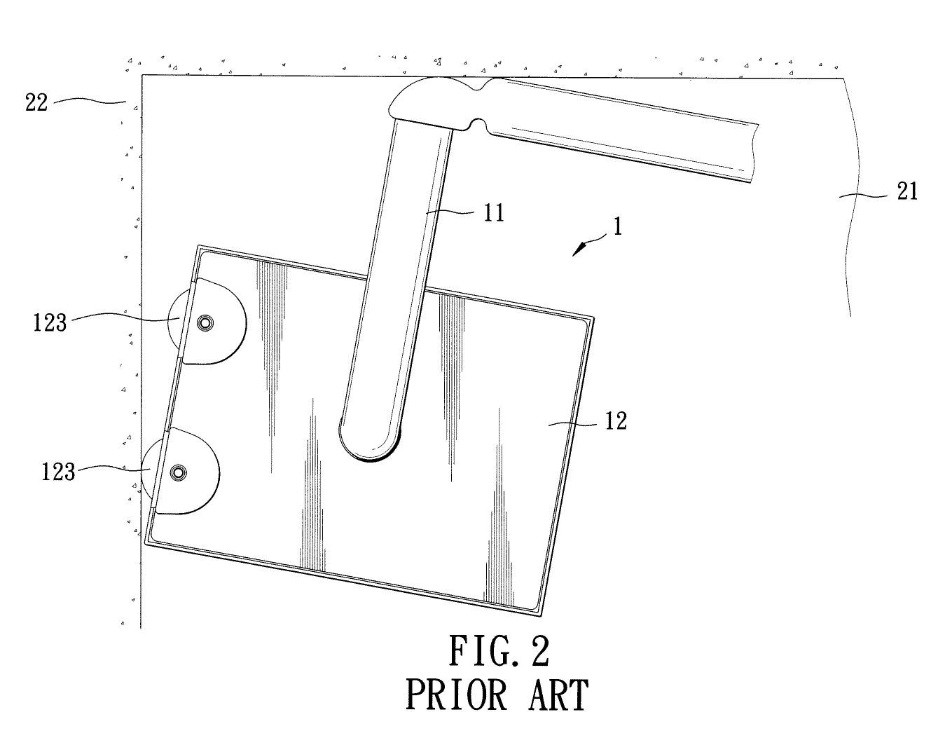

### DETAILED DESCRIPTION OF THE PREFERRED EMBODIMENTS

Before the present invention is described in greater detail, it should be noted that like elements are denoted by the same reference numerals throughout the disclosure.

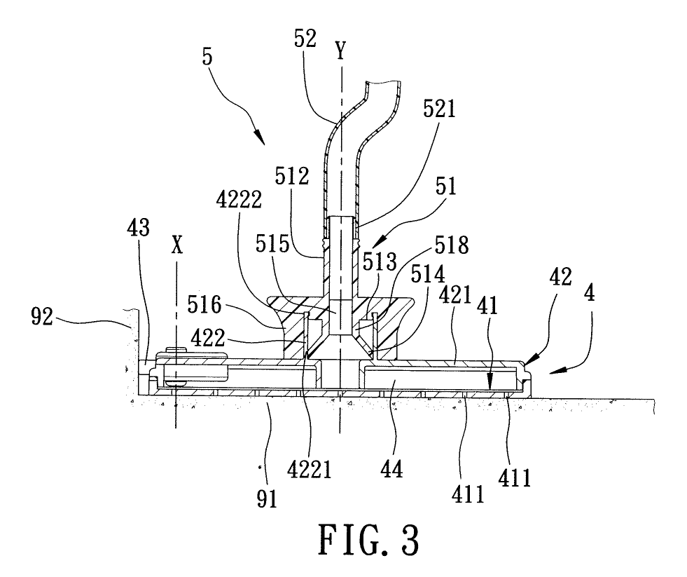

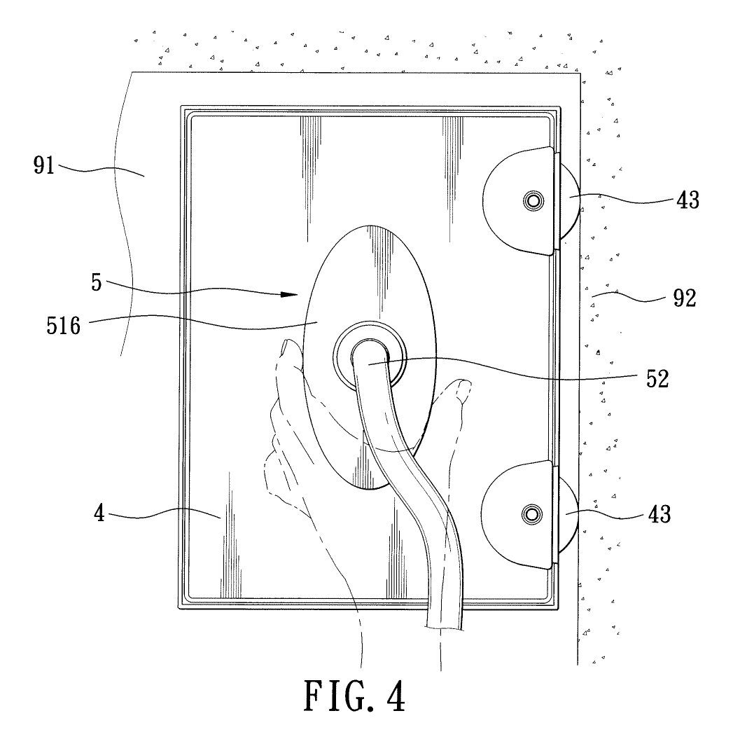

Referring to FIGS. 3 and 4, the first preferred embodiment of a paint applicator according to this invention is shown to include an applying unit 4 and a joining unit 5. The paint applicator is illustrated specifically for painting an edge portion of a first wall 91 proximate to a second wall 92.

The applying unit 4 includes a flat casing 42, an applying plate 41 covering the flat casing 42 and cooperating with the flat casing 42 to define a receiving space 44, and two rollers 43 mounted on the flat casing 42 externally of and at one side of the receiving space 44. The applying plate 41 has a plurality of paint outlet holes 411 spaced apart from each other. The flat casing 42 includes a back plate 421 opposite to the applying plate 41, and a passage tube 422 having an inner end 4221 connected to the back plate 421 and an outer end 4222 extending away from the receiving space 44. Each of the rollers 43 projects outward from the flat casing 42 and is rotatable about a first axis (X) transverse to the applying plate 41.

The joining unit 5 includes a joining member 51 connected pivotally to the flat casing 42, and opposite to the applying plate 41 and rotatable around a second axis (Y) parallel to the first axis (X). The joining member 51 includes an output passage 515 communicated fluidly with the receiving space 44 of the applying unit 4 and adapted to supply paint material to the receiving space 44. The joining member 51 has a first engaging part 513 inserted rotatably into and engaging sealingly the outer end 4222 of the passage tube 422, a second engaging part 514 extending within and engaging rotatably and sealingly the inner end 4221 of the passage tube 422, and a neck portion 518 disposed between the first and second engaging parts 513, 514 and spaced apart from an inner surface of the passage tube 422. The output passage 515 extends through the first and second engaging parts 513, 514 and the neck portion 518.

The joining unit 5 further includes a hose 52 having a first end portion 521 connected to the joining member 51 and communicated fluidly with the output passage 515. The joining member 51 further includes a handle member 516 projecting outwardly from the first engaging part 513 and extending around the passage tube 422, and a connecting portion 512 extending outwardly from the first engaging part 513 and away from the applying unit 4. The connecting portion 512 is a hollow member that projects from the first engaging part 513 and that is connected fluidly to the output passage 515. The hose 52 is connected fluidly to the hollow member.

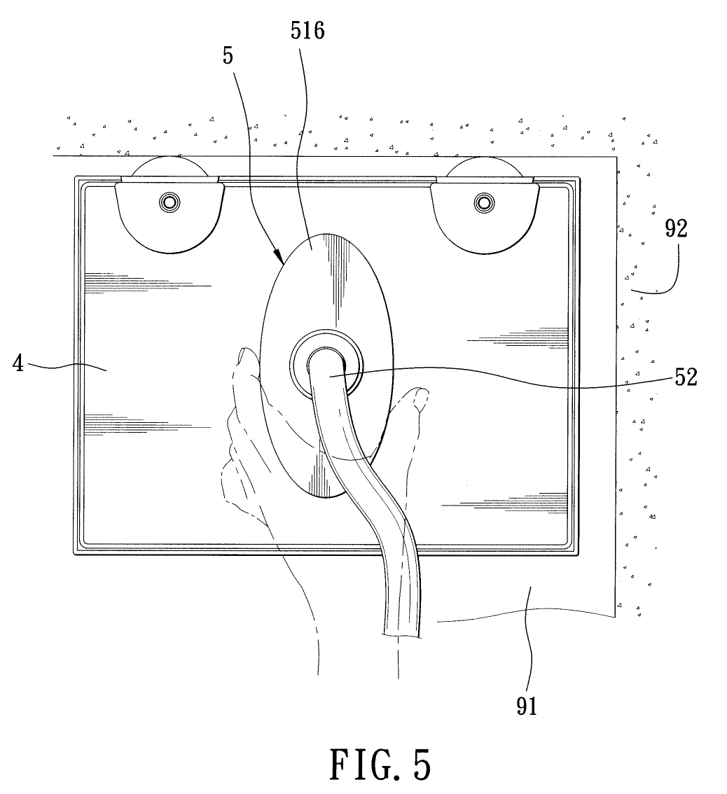

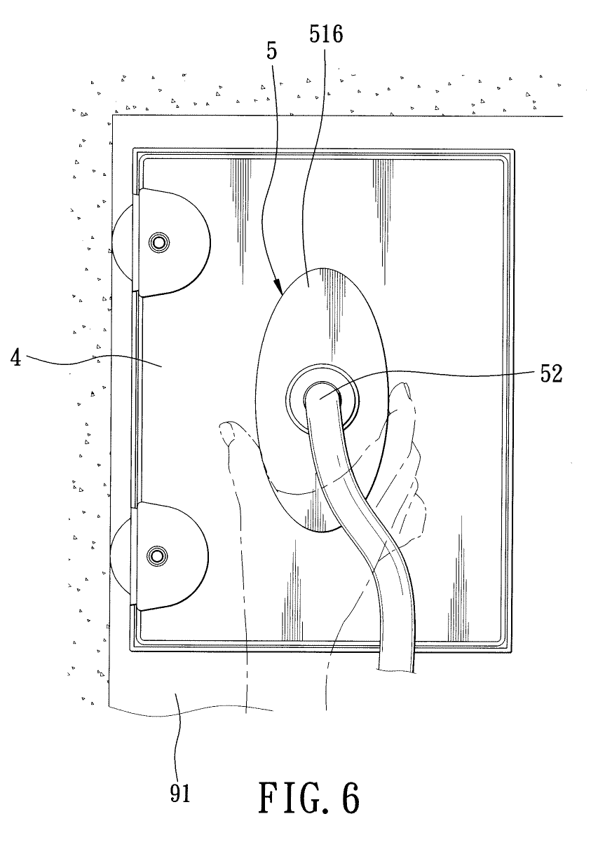

Referring to FIGS. 4, 5, and 6, in use, paint flows through the hose 52 and the output passage 515 into the receiving space 44 of the applying unit 4, and then flows out of the receiving space 44 through the paint outlet holes 411 so as to paint the first wall 91.

Since the joining member 51 of the joining unit 5 is connected pivotally to the flat casing 42 of the applying unit 4, the joining member 51 of the joining unit 5 is rotatable relatively to the applying unit 4, and thus, the use of the paint applicator of the present invention for painting an edge area of a wall (for example, the edge area of the first wall 91 proximate to the second wall 92) is relatively flexible as compared to the prior art.

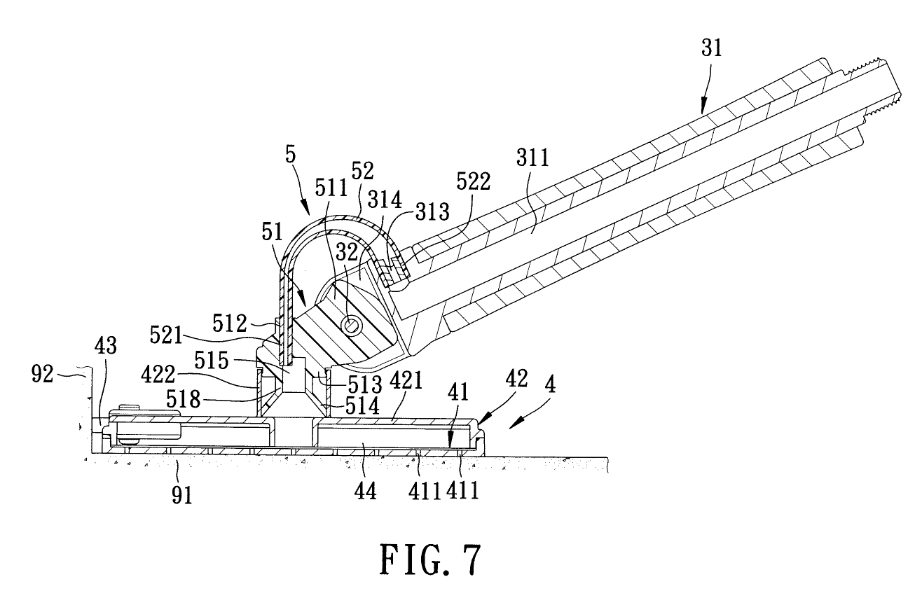

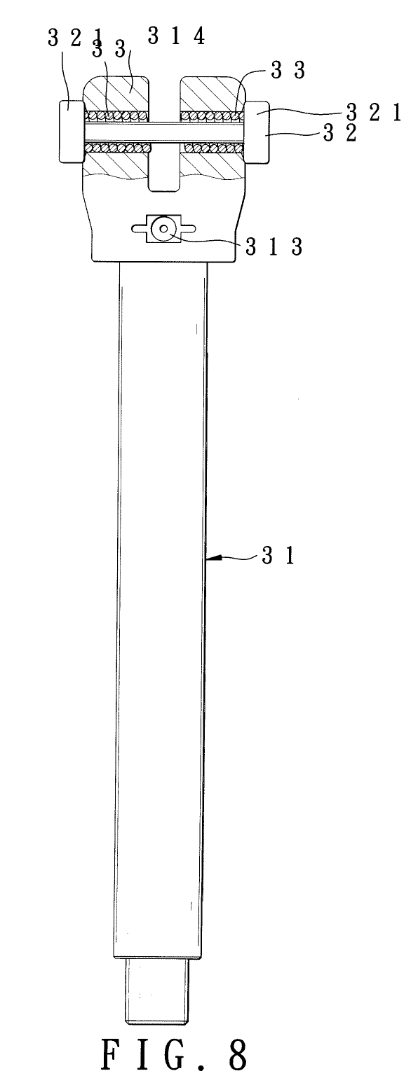

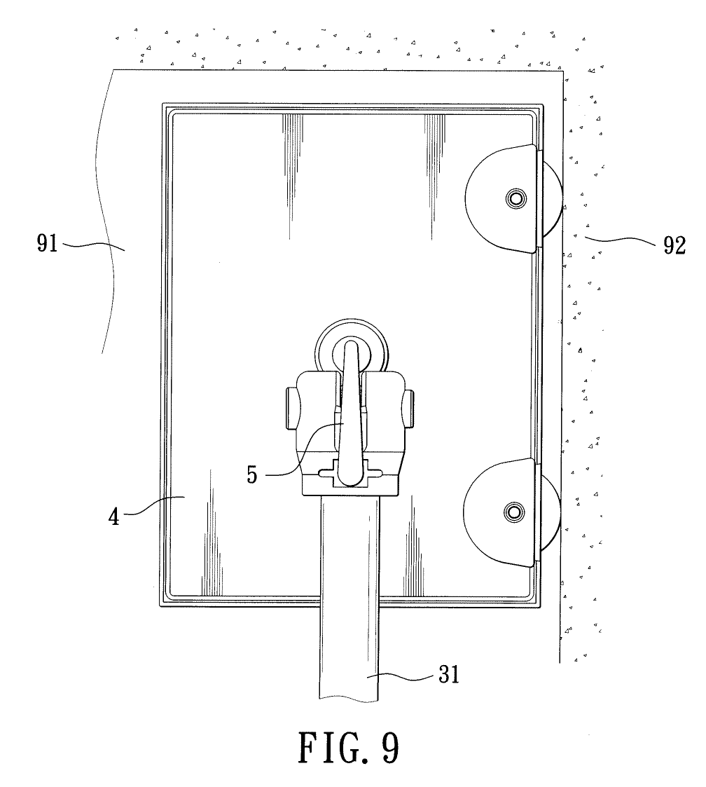

Referring to FIGS. 7, 8, and 9, the second preferred embodiment of a paint applicator according to this invention is shown to be substantially similar to the first preferred embodiment except for the following. The second preferred embodiment further includes a hollow rod handle 31 defining an input passage 311. The joining member 51 further includes a connecting portion 511 extending outwardly from the first engaging part 513 and away from the flat casing 42. The hollow rod handle 31 is connected pivotally to the connecting portion 511. The hose 52 further has a second end portion 522 opposite to the first end portion 521 and connected to the hollow rod handle 31 and in fluid communication with the input passage 311. The hollow rod handle 31 has one end provided with a bifurcated pivot portion 314 pivoted to and sandwiching the connecting portion 511, and a connecting hole 313 connected fluidly to the second end portion 522 of the hose 52 and the input passage 311. The hollow rod handle 31 further has a bolt 32 extending through the bifurcated pivot portion 314 and the connecting portion 511 of the joining member 51 and having two opposite headed ends 321 at two ends of the bifurcated pivot portion 314, and a pair of resilient members 33 mounted around the bolt 32 and spaced apart from each other by the connecting portion 511 of the joining member 51. Each of the resilient members 33 abuts against one of the headed ends 321 and the connecting portion 511.

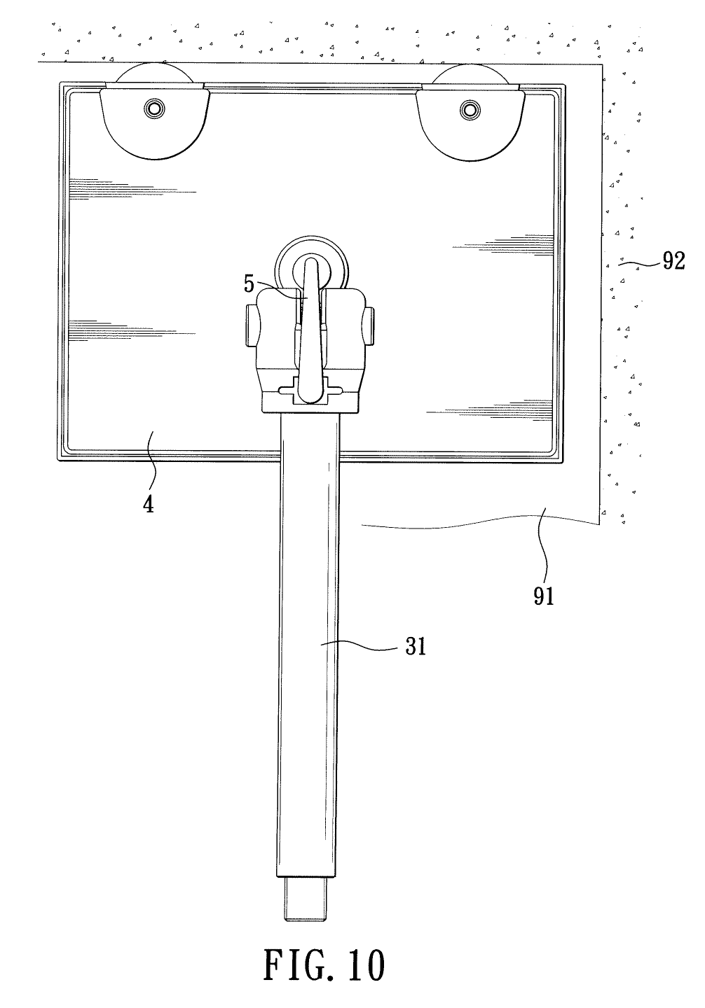

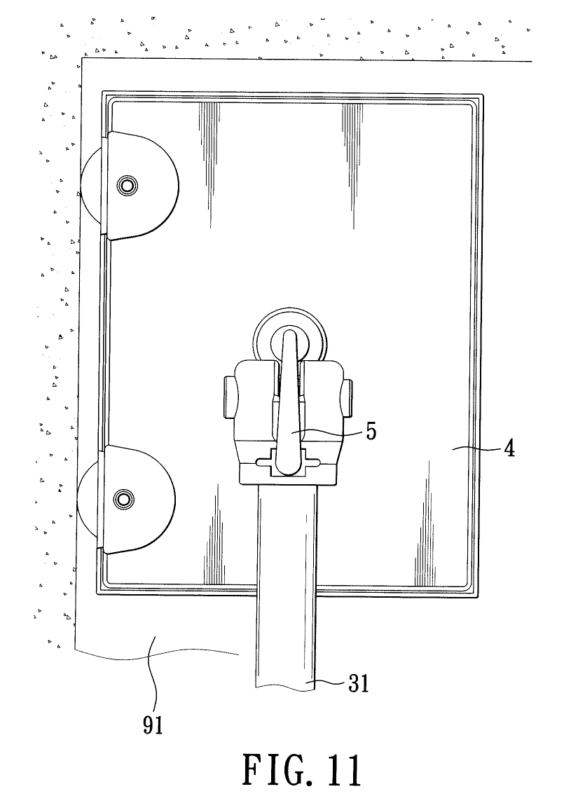

Referring to FIGS. 7, 9, 10, and 11, in use, the paint flows through the input passage 311, the hose 52 and the output passage 515 into the receiving space 44 of the applying unit 4, and then flows out of the receiving space 44 through the paint outlet holes 411 so as to paint the first wall 91.

Since the joining member 51 of the joining unit 5 together with the hollow rod handle 31 is rotatable relative to the flat casing 42 of the applying unit 4, the use of the paint applicator of the present invention for painting an edge area of a wall (for example, the edge area of the first wall 91 proximate to the second wall 92) is relatively flexible as compared to the prior art.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A paint applicator comprising:
an applying unit including a flat casing, an applying plate covering said flat casing and cooperating with said flat casing to define a receiving space, and at least one roller mounted on said flat casing externally of and at one side of said receiving space, said applying plate having a plurality of paint outlet holes spaced apart from each other, said roller projecting outward from said flat casing and being rotatable about a first axis transverse to said applying plate; and
a joining unit including a joining member connected pivotally to said flat casing, and opposite to said applying plate and rotatable around a second axis parallel to said first axis, said joining member including an output passage communicated fluidly with said receiving space of said applying unit and adapted to supply paint material to said receiving space.

2. The paint applicator as claimed in claim 1, wherein said flat casing includes a back plate opposite to said applying plate, and a passage tube having an inner end connected to said back plate and an outer end extending away from said receiving space, said joining member having a first engaging part inserted rotatably into and engaging sealingly said outer end of said passage tube.

3. The paint applicator as claimed in claim 2, wherein said joining member further has a second engaging part extending within and engaging rotatably and sealingly said inner end of said passage tube, and a neck portion disposed between said first and second engaging parts and spaced apart from an inner surface of said passage tube, said output passage extending through said first and second engaging parts and said neck portion.

4. The paint applicator as claimed in claim 2, wherein said joining unit further includes a hose having a first end portion connected to said joining member and communicated fluidly with said output passage.

5. The paint applicator as claimed in claim 4, wherein said joining member further includes a handle member projecting outwardly from said first engaging part and extending around said passage tube, and a connecting portion extending outwardly from said first engaging part and away from said applying unit.

6. The paint applicator as claimed in claim 5, wherein said connecting portion is a hollow member that projects from said first engaging part and that is connected fluidly to said output passage, said hose being connected fluidly to said hollow member.

7. The paint applicator as claimed in claim 4, further comprising a hollow rod handle defining an input passage, said joining member further including a connecting portion extending outwardly from said first engaging part and away from said flat casing, said hollow rod handle being connected pivotally to said connecting portion, said hose further having a second end portion opposite to said first end portion and connected to said hollow rod handle and in fluid communication with said input passage.

8. The paint applicator as claimed in claim 7, wherein said hollow rod handle has one end provided with a bifurcated pivot portion pivoted to and sandwiching said connecting portion, and a connecting hole connected fluidly to said second end portion of said hose and said input passage.

9. The paint applicator as claimed in claim 8, wherein said hollow rod handle further has a bolt extending through said bifurcated pivot portion and said connecting portion of said joining member and having two opposite headed ends at two ends of said bifurcated pivot portion, and a pair of resilient members mounted around said bolt and spaced apart from each other by said connecting portion of said joining member, each of said resilient members abutting against one of said headed ends and said connecting portion.
